(19) United States
(12) Patent Application Publication
(10) Pub. No.: US 2010/0089168 A1
(43) Pub. Date: Apr. 15, 2010

(54) ACTUATING DEVICE WITH POSITION SENSING DEVICE

(76) Inventors: Werner Schnabel, Regensburg (DE); Alessandro Spathas, Regensburg (DE); Uwe Grass, Stuttgart (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/438,380

(22) PCT Filed: Aug. 17, 2007
(86) PCT No.: PCT/EP2007/058584

§ 371 Date: Nov. 25, 2009

(30) Foreign Application Priority Data
Aug. 23, 2006 (DE) 10 2006 039 521.2

(51) Int. Cl. G01L 9/00; G01D 7/00

(52) U.S. Cl. 73/705; 73/866.1

(57) ABSTRACT

The present invention relates to an actuating device (12) with a pressure cell (1) for actuating mechanical systems by means of an actuating rod (13). To determine intermediate positions of the actuating rod (13) in a simple and inexpensive way, a housing (17) of the pressure cell (1) consists entirely or partially of a translucent plastic. Furthermore, a lug (4, 5) that is firmly connected to the actuating rod (13) is provided inside a chamber (14) of the pressure cell (1), with a light barrier (3, 6) arranged outside the pressure cell (1) to detect the position of the lug (4, 5).

The present invention relates to an actuating device with a pressure cell for actuating mechanical systems via an actuating rod, wherein the pressure cell includes two chambers with differing pressure conditions that are separated from one another by a diaphragm. The invention further relates to a position sensing device for generating an electrical position signal that correlates to a relative position between two components. The invention also relates to a servo drive for such an actuating device and such a position sensing device.

Electrically operated hydraulic and pneumatic actuating devices may be used to actuate mechanical systems, for example to move flap gates or actuate valves. Actuating devices that are operated pneumatically normally include a pressure cell, that is to say a pneumatic system in which a partial vacuum is created on one side of a diaphragm while extra pressure or ambient pressure is applied on the other side. The resulting pressure differential causes a force to be exerted on the diaphragm, which transfers the force via an actuating rod. This is a linear force motion. A spring force acts against the force on the diaphragm, and the travel of the diaphragm thus determined in correspondence with the pressure differential. In this case, the position of the actuating rod at any given moment is not reported.

In order to receive location or position reports, mechanical switches or magnetic systems such as Hall probes may be used to determine the respective end positions of the actuating rod. Hall probes may also be used to record intermediate positions. However, the drawback of this arrangement is that switches and Hall sensors are expensive, particularly due to the cost of the large, long magnets for actuating the Hall sensors. Since magnetic position sensing functions without contact, the higher costs associated with such devices have been accepted.

German patent no. DE 20 2006 000 528 U1 describes a transparent sensor housing made of plastic for optical radiation of a sensor.

U.S. patent no. U.S. Pat. No. 3,100,997 describes a pressure measurement cell in which a diaphragm separates an evacuated chamber from a measuring chamber and bears a screen with adjacently disposed transparent and opaque strips, the screen being positioned movably in an optical path of a light barrier. The pressure measurement cell has a glass housing and works with a light barrier, the transmitter and receiver of which are arranged on the outside of the housing, and which deflects the light along the optical path from the transmitter to the receiver by means of a mirror arrangement.

The present invention addresses the problem of suggesting an improved embodiment of an actuating device of the type described in the introduction, and of a position sensing device of the type described, and of a servo drive equipped with such an actuating device and position sensing device, and is characterized particularly in that intermediate positions as well as end positions of a component, particularly an actuating rod, may be determined in a simple and inexpensive way.

This problem is solved according to the invention by the objects of the independent claims. Advantageous embodiments are the objects of the dependent claims.

To resolve this problem, the present invention suggests three different, independent solutions, an actuating device, a position sensing device, and a servo drive. All three solutions are based on the common, more general idea with respect to two components that are movable relative to one another, of equipping one component with a lug and the other with a light barrier which cooperates with the lug to generate an electrical position signal. Thus, positions may be recorded without contact in this way also, and the device functions without the use of expensive magnets, so that it may be produced relatively inexpensively. These days, light barriers in particular can be produced with extremely inexpensive semiconductor elements such as light emitting diodes and transistors.

This objective is achieved for the actuating device working with a pressure cell in that a housing of this pressure cell is made entirely or partly from a translucent plastic, wherein a lug that is permanently affixed to the actuating rod is provided inside one of the two chambers of the pressure cell, which constitutes a clean chamber, and wherein a light barrier is located outside the pressure cell to detect the position of the lug. In this way, a contactless system using simple, inexpensive parts may be provided in an actuating system that operates with a pressure cell, in order to obtain a position report or position signal for the actuating rod. Thus, a position sensing device consisting of the lug and the light barrier cooperating therewith is integrated in the suggested actuating device.

The problem the invention is intended to address is thus solved with the suggested position sensing device in that it has two components that are arranged so as to be movable bidirectionally relative to one another in one stroke direction, and of which one is equipped with the lug and the other with the light barrier. In this way, the light barrier cooperating with the lug may generate an electrical position signal correlated with the relative position of the two components depending on the positions of the lug and the light barrier relative to one another. The position sensing device formed in this way may also be produced inexpensively. Moreover, it may be combined extremely easily with a servo drive intended to drive a final control element bidirectionally. To this end, the component bearing the lug of the position sensing device simply needs to be coupled to an actuating rod that serves to actuate the final control member.

The problem the invention is intended to address is also solved by a servo drive that either includes the actuating device with integrated position sensing according to the invention, or is equipped with any actuating device and the position sensing device according to the invention.

Further important features and advantage of the invention will be evident from the subordinate claims, the drawings and the associated description of the figures with reference to the drawings.

Of course, the features described in the preceding as well as those that will be explained in the following text may be used not only in the combination indicated in each case, but also in other combinations or independently without exceeding the scope of the present invention.

Preferred embodiments of the invention are shown in the drawings, and are explained in greater detail in the following description, in which the same reference numbers are used to indicate identical or similar or functionally equivalent components.

In the following diagrammatic drawings,

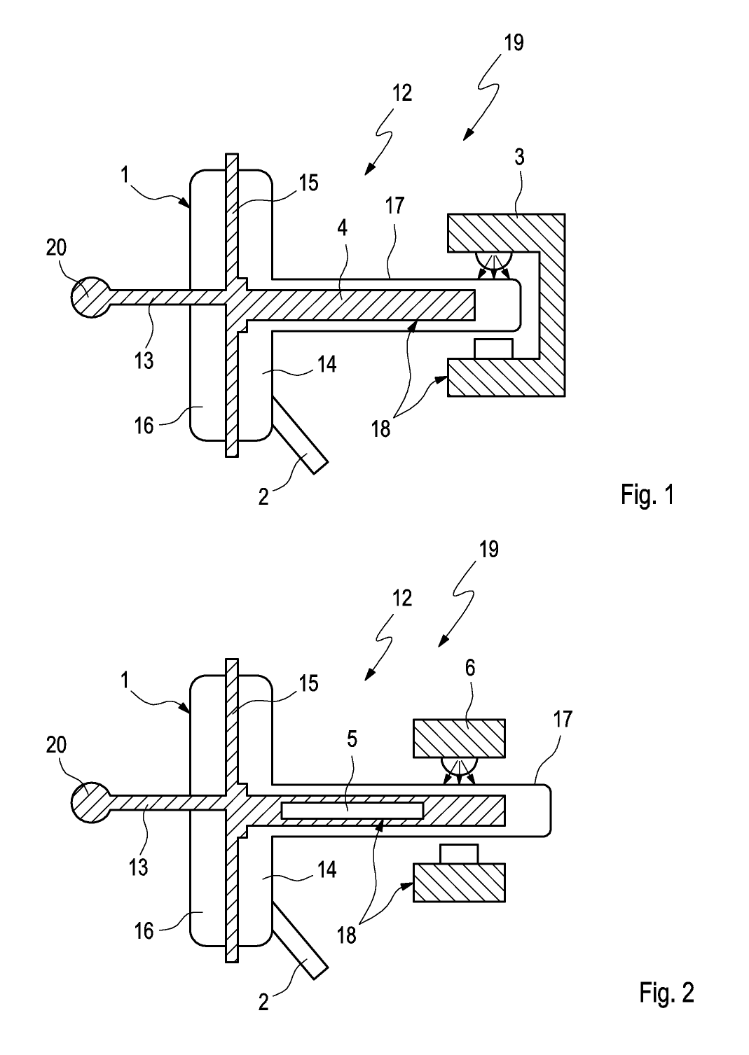

FIG. 1 shows an actuating device having a pressure cell with an actuating rod, an uncoded lug and a fork light barrier,

FIG. 2 shows an actuating device having a pressure cell with an actuating rod, a coded lug and a light barrier,

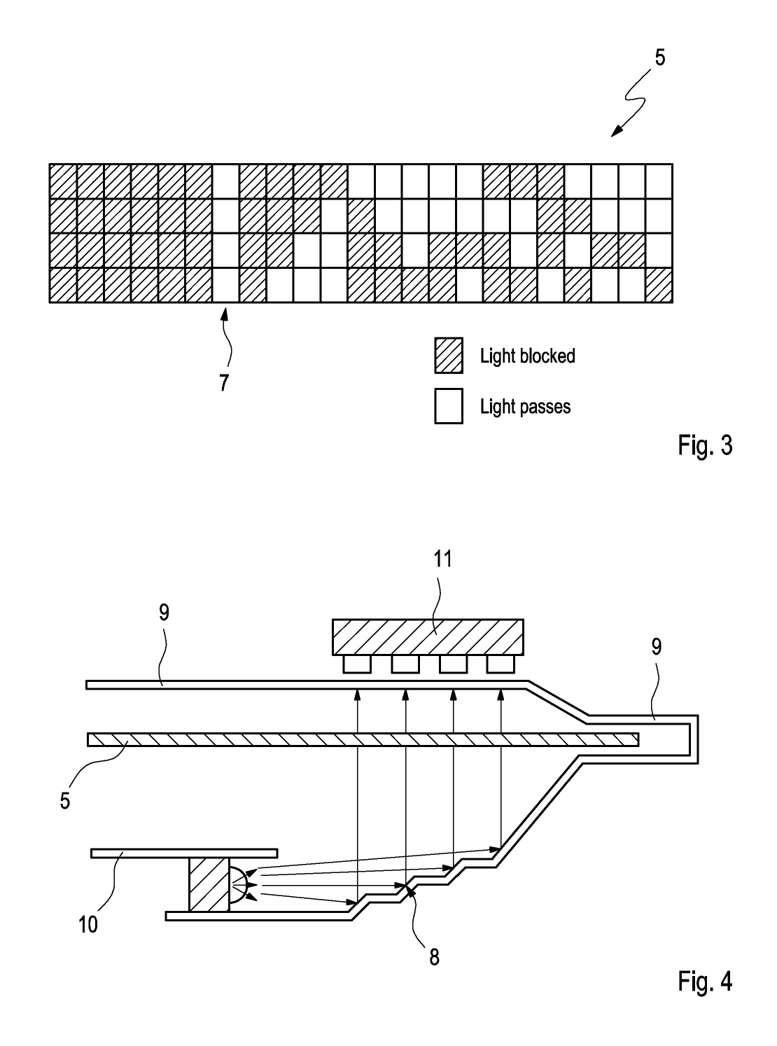

FIG. 3 shows an embodiment of a coded lug,

FIG. 4 is a partial view of another embodiment of an actuating device having a pressure cell with an actuating rod and a coded lug,

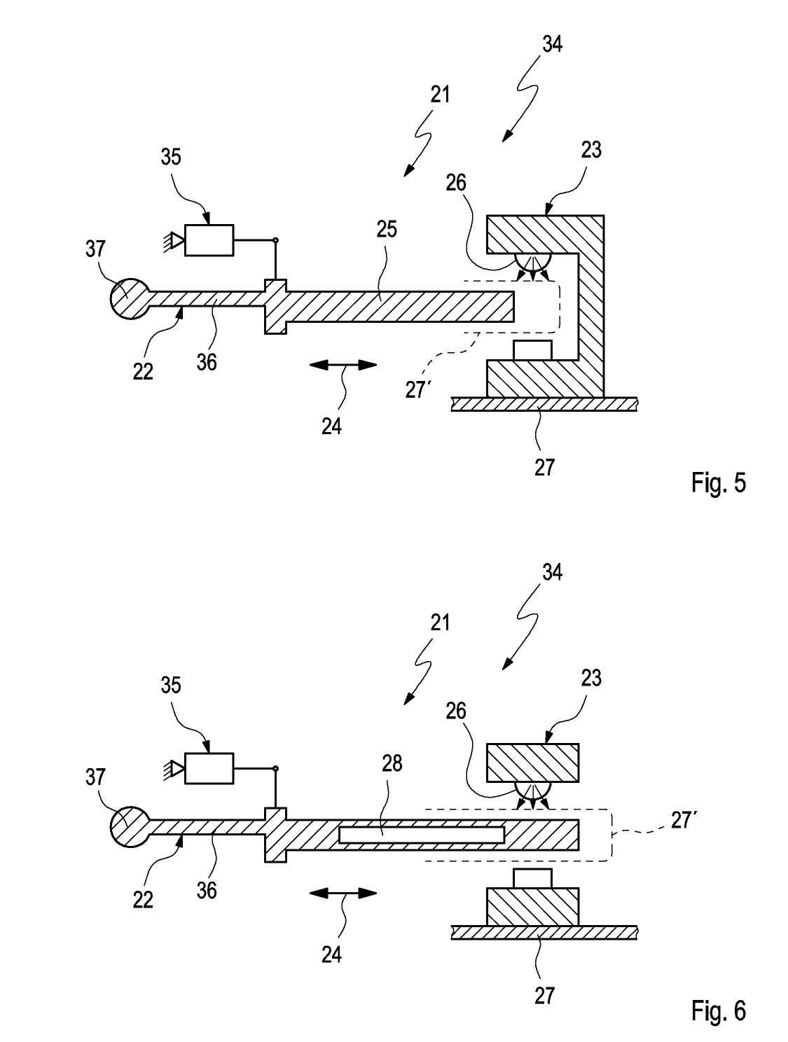

FIG. 5 is position sensing device with an uncoded lug and a fork light barrier,

FIG. 6 is a position sensing device with a coded lug and a fork light barrier,

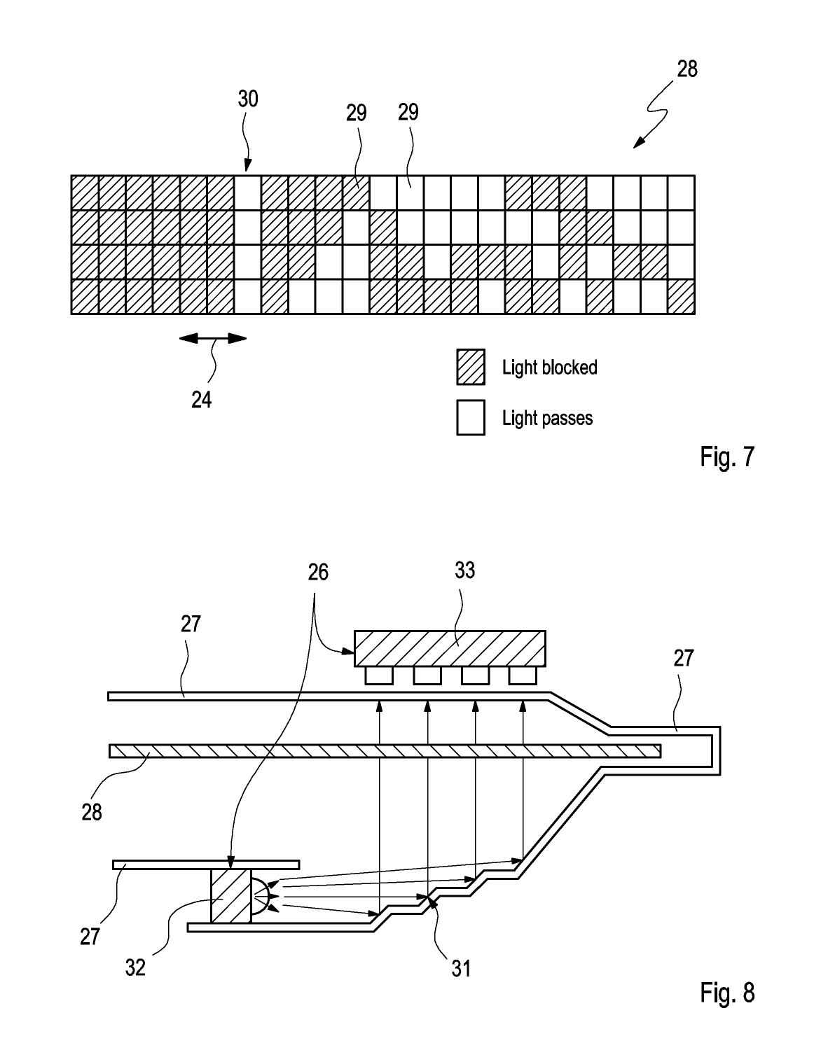

FIG. 7 is an embodiment of a coded lug,

FIG. 8 is a partial view of another embodiment of a position sensing device with a coded lug.

FIGS. 1 to 8 are diagrammatic representations in which only the components that are essential to an understanding of the invention are shown.

Translucent plastics have been known for some time. They also allow the passage of laser light. Special embodiments of these translucent plastics appear black to the human eye, but are translucent for light at a certain wavelength. If, for example, a housing of the underpressure side in a pressure cell is made from this material and a lug is disposed in the housing on the underpressure side of the diaphragm, a light barrier may be placed on the outside of the pressure cell to cooperate with the lug on the inside. The light for the light barrier passes almost entirely unhindered through the plastic, which is translucent at least for the wavelength of the light for the light barrier, so that expensive cable feedthroughs are not required. The light barrier, which is actuated by or cooperates with the lug on the inside, may be a fork light barrier or a reflex light barrier, or it may consist of a light barrier system consisting of at least two components, in particular a transmitter, e.g. in the form of an emitter diode, and a receiver, e.g. a light-sensitive transistor.

FIG. 1 shows an embodiment of an actuating device having a pressure cell with an uncoded lug and a fork light barrier.

As shown in FIG. 1, an actuating device 12 includes a pressure cell 1 with an actuating rod 13, which is equipped with a lug 4 in a chamber 14. Pressure cell 1 further contains a diaphragm 15 that separates the first chamber 14 from the second chamber 16. A partial vacuum connection is indicated by the number 2. An end position of actuating rod 13 may be determined with the aid of fork light barrier 3. In particular, this may be an upper or a lower end position in this case. The end position may be checked most simply using a fork light barrier 3 or a reflex light barrier, since both instruments consist of a single unit. This unit is attached to or on pressure cell 1 in such a way that no dirt can get into the optical path.

Pressure cell 1 has a housing 17 made from a plastic that is translucent for the light of light barrier 3. Accordingly, light barrier 3 may be situated on the outside of housing 17 and still cooperate with the lug 4 disposed inside housing 17. Chamber 14, in which lug 4 is disposed, is preferably designed as a clean chamber. This clean chamber is sealed off from the outside, for example.

Light barrier 3 and lug 4 together form a position sensing device 18. In this case, this position sensing device 18 is integrated in the construction of actuating device 12, forming a single unit that may also be described as a servo drive 19. A servo drive 19 of such kind may be used for bidirectional driving of a final control element (not shown here) in basically any mechanical system. The end section 20 of actuating rod 13 opposite the end bearing lug 4 may be coupled to such final control element for this purpose.

FIG. 2 shows an actuating element 12 having a pressure cell 1 that is equipped with an actuating rod 13. With this embodiment, it is possible to detect intermediate positions of actuating rod 13. For this purpose, several light barriers 6 are installed, though only one light barrier 6 is illustrated in the embodiment shown. The pressure cell 1 shown in FIG. 2 is equipped with a coded lug 5. Coded lug is shown in greater detail in FIG. 3. In this embodiment as well, the at least one light barrier 6 and lug 5 together form a position sensing device 18, which is integrated in actuating device 12. The unit produced in this way again serves as a servo drive 19 for bidirectional driving of a final control element (not shown) in any mechanical system.

As shown in FIG. 3, lug 5 may be divided into zones or surfaces or fields, wherein the unshaded allow light to pass through and the shaded zones block the light. In this context, this translucency applies at least to the wavelength of the light barrier 6 that is used. Now if for example four zones are arranged in a row, called a check row 7, over the width of lug 5, four light barriers are needed and a position report of four bits is possible. For example, if a flap gate is moved through 90°, this means positioning though 5.6°.

In another, cheaper solution, a single transmitter, for example an appropriate light emitting diode, may be used to transmit light through a mirror arrangement to the light-sensitive receivers, for example transistors. The mirror arrangement may consist for example of injected mirrors, which work with total reflection in plastic materials. This is an inexpensive way to obtain considerably more bits. FIG. 4 shows an embodiment in which this solution is used. In FIG. 4, a translucent housing is designated with the number 9, the mirror arrangement with 8, the coded lug with 5, the light emitting diode with 10, and the light-sensitive transistors serving as receivers with 11.

In another embodiment (not illustrated), the position of the lug may be determined in essentially the same way as the position of a cursor is determined using a “ball-less” computer mouse. In such an embodiment, a reflection light barrier is used, and the relative motion of the lug is determined by a corresponding chip. However, this embodiment needs to be adjusted occasionally for the purposes of the present application. Such adjustment may always be made when the end position is reached. Accordingly, the position of the lug should be recalculated from the end position constantly.

Since a laser-compatible plastic material is used for housing 9 or 17 of pressure cell 1, pressure cell 1 may also be welding with a laser. The following is a list of the advantages of the present invention, at least with reference to the embodiments shown in FIGS. 1 to 4:

1. Use of a light barrier as switching element. This is inexpensive and provides a reliable signal.

2. Use of a black plastic that is translucent for the wavelength of the light emitting diodes.

3. The components of the light barrier are located outside the chamber in which underpressure or overpressure is created, so no expensive and unreliable feedthroughs are required.

4. The lug for actuating the light barrier is located in the clean chamber on the side of the pressure cell with underpressure or overpressure.

5. Use of multiple receiving transistors enables intermediate positions to be determined. The lug has corresponding digital coding.

6. The plastic part of the underpressure or overpressure side is able to be injected to produce mirrors, so that the light from a single light emitting diode may be split.

As shown in FIGS. 5 and 6, a position sensing device 21 includes a first component 22 and a second component 23. Position sensing device 21 may be used to generate an electrical position signal that correlates with the relative position between the two components 22, 23. For this purpose, both components 22, 23 are arranged adjacent each other inside position sensing device 21 so as to be movable bidirectionally relative to one another in a stroke direction 24 indicated by a double-headed arrow. For example, first component 22 may be supported in stroke-adjustable manner on second component 23. To this end, for exemplary purposes only and without limitation of the general principle, second component 23 may be equipped with a rail (not shown here) for linear guidance of first component 22.

First component 22 has a lug 25, which is immovable relative to first component 22. Second component 23 has at least one light barrier 26, which is immovable relative to second component 23. This light barrier 26 is disposed in a travel path (not shown in detail) of lug 25. To this extent, light barrier 26 is able to cooperate with lug 25 to generate an electrical position signal on the basis of the relative positions of lug 25 and light barrier 26, which signal then correlates with the positions of the two components 22, 23 relative to one another.

In this context, light barrier 26 may generally be located outside of a housing 27 (indicated by a dashed line), which then forms part of second component 23. In this case, housing 27 is made from a material that allows the light of light barrier 26 to pass through, particularly a plastic. However, the embodiment shown here is preferred, according to which light barrier 26 is located inside housing 27, of which only a small part is shown in this figure. Advantageously, this housing 27 also serves as a part of second component 23.

In the embodiment shown in FIG. 5, light barrier 26 is designed as a fork light barrier. A fork light barrier 23 of such kind may be assembled and fitted as a single unit, thus making it more manageable.

As shown in FIG. 6, use of a coded lug 28 may be envisaged with a different embodiment. As shown in FIG. 7, coded lug 28 may be made up of a plurality of adjacent fields or surfaces or zones 29, certain of which, the zones 29 that are shaded, are not translucent, at least to the light of light barrier 26, and other zones 29, appearing unshaded in the figure, are translucent, at least for the light of light barrier 26. The chosen arrangement of adjacent translucent and non-translucent zones 29 forms a digital code for lug 28. In the example, four such zones 29 are arranged adjacent each other over each width of lug 28, forming a check row 30. Accordingly, a 4-bit code may be created. Of course, it is also possible to arrange more or fewer adjacent zones 29 in the respective check row 30.

In the embodiment shown in FIG. 6, four or more or fewer light barriers 26 may be arranged next to each other over the width of lug 28, which extends perpendicularly to stroke direction 24, corresponding to the number of zones 29 that are arranged within the respective check row 30. In FIG. 6, however, only one such light barrier 26 is shown. In another embodiment, it is generally possible to provide only one transmitter, which transmits light to multiple receivers. In this case, the respective light barrier 26 may function with a mirror arrangement 31, as shown in FIG. 8, which distributes the light originating from a single light source (light emitting diode) 32 to a receiver array 33. Receiver array 33 may have a number of separate receivers, particularly light-sensitive transistors, corresponding to the coding bit depth of lug 28. Equally, receiver array 33 may consist of a common receiver, particularly in the form of a light-sensitive transistor, that is able to record and evaluate a number of adjacent zones corresponding to the coding bit depth of lug 28.

FIG. 8 also shows coded lug 28, and a purely exemplary illustration of housing 27, which in this case is also designed to be translucent, at least for the light of light barrier 26.

Light barrier 26 which cooperates with this coded lug 28 is thus equipped with at least one light emitting diode on one side of lug 28, and with at least one light-sensitive transistor on the other side of lug 28.

Mirror arrangement 31 particularly lends itself to injection in plastic, in which case it works with total reflection. In particular, mirror arrangement 31 may be injected into housing 27.

In another embodiment (not shown here), light barrier 26 may be designed as a reflection light barrier, which detects the motion of lug 28 or the motion of lug 25 using an appropriate chip (integrated circuit) and converts it to a corresponding position signal. Reflection light barriers of such kind that cooperate with such a chip to determine position, are known for instance from computer technology and are used to calculate the position of a cursor that is movable on a monitor with a mouse. The computer mouse used for this functions without a ball, but with at least one such reflection light barrier, by which the movement of the mouse relative to an underlying surface may be detected. The motion signal that can be calculated in this way may be used to control the cursor. In the present case, this principle may be used to determine the position of the lug. In this case, it is advantageous to carry out a position comparison with a reference position from time to time. This may be done very easily when the end position of the lug or the components is reached.

As was explained previously, second component 23 may form a housing into which first component 22 protrudes. Light barrier 26 may then be disposed inside housing 27. As shown in the embodiments of FIGS. 5 and 6, position sensing device 21 may preferably form a part of a servo drive 34. This servo drive is used for bidirectional driving of a final control element (not shown here) of practically any mechanical system. Besides the position sensing device 21, servo drive 34 also includes an actuating device 35, which is represented here for exemplary purposes only and without limitation of the general principle by a piston-cylinder unit. Actuating device 35 is used to actuate a bidirectionally movable actuating rod 36, which in this case is constituted by first component 22. Actuating rod 36 may equally well be a separate element, in which case first component 22 of position sensing device 21 is coupled to this actuating rod 36 by suitable means. Actuating rod 36 may be connected in driving manner to the final control element that is to be driven by servo drive 34 for example via a connection zone 37.

Actuating device 35 may essentially be formed by the actuating device 12 that was described in detail with reference to FIGS. 1 to 4. Position sensing device 21 is then practically integrated in actuating device 35. Alternatively, the actuating device 35 and the position sensing device 21 may equally be completely separate systems cooperate in appropriate manner. In this case, it is particularly possible to accommodate position sensing device 21 completely in a housing of actuating device 35. In this way, an integrated servo motor 34 containing both actuating device 35 and position sensing device 21 integrally is provided.

Actuating device 35 may thus operate pneumatically and thus particularly be equipped with a pressure cell 1. Alternatively, actuating device 35 may also operate hydraulically. An actuating device 35 that functions electrically is equally possible.

Servo drive 34 may be used for example to actuate a valve element in an exhaust gas recirculation system. For example actuating rod 36 may drive the valve element of an exhaust gas recirculation valve to adjust the rate at which exhaust gases are recirculated. Alternatively servo drive 34 may be used to actuate a final control element of an exhaust turbocharger. For example, an exhaust turbocharger is equipped with a wastegate valve that allows the inlet side of the turbine to communicate with the outlet side of the turbine under low loads. The exhaust turbocharger may also be equipped with adjustable guide vane geometry. In this case, servo drive 34 may be used to actuate the wastegate valve or the guide vane adjustment.

1. An actuating device for actuating mechanical systems by an actuating rod, comprising:
a pressure cell having two chambers with differing pressure conditions,
a diaphragm connected in driving manner to the actuating rod, wherein the two chambers are separated by the diaphragm,
housing of the pressure cell that is constructed at least partly from a translucent plastic,
a lug provided inside one of the two chambers that constitutes a clean chamber and is attached permanently to the actuating rod, and
at least one light barrier detecting an end position of the lug that is situated outside the pressure cell.

2. The actuating device according to claim 1, wherein the light barrier is a fork light barrier that is located in an end area of the lug and determines the end position of the lug.

3. The actuating device according to claim 1, wherein the lug has an arrangement of adjacent surfaces that are one of translucent and non-translucent, and which together form a coding, at least one light emitting diode is arranged on one side of the lug, and at least one light-sensitive transistor is arranged on the other side of the lug outside the chamber.

4. The actuating device according to claim 1, wherein a plastic part of one of the chambers is injected such manner that mirrors are formed on the inside thereof and these mirrors distribute light from a light emitting diode.

5. The actuating device according to claim 1, wherein the at least one light barrier is a reflection light barrier, wherein the movement of the lug is registered by a chip.

6. A position sensing device for generating an electrical position signal, comprising:
two components where the electrical position signal correlates with a relative position between the two components, wherein the one component is arranged on the other component so as to be movable bidirectionally in a stroke direction,
a lug including a travel path, the lug included with the first component;
at least one light barrier included with the second component, where the at least one light barrier is located in the travel path of the lug and which generates an electrical position signal that is correlated with the relative position of the two components depending on the relative position between the lug and the light barrier, and
at least one light emitting transmitting device included with the light barrier on one side of the lug and at least one light-sensitive receiving device on the other side of the lug,
wherein the lug has an arrangement of one of adjacent translucent and adjacent non-translucent surfaces, which together form a coding.

7. The position sensing device according to claim 6, wherein the second component has a mirror arrangement to distribute light of a transmitting device to one of multiple receiving devices and one receiving array.

8. The position sensing device according to claim 6, wherein the light barrier is designed as a reflection light barrier that calculates the movement of the lug and converts the movement into a position signal by chip.

9. The position sensing device according to claim 6, wherein the second component has a housing into which the first component protrudes.

10. The position sensing device according to claim 6, wherein at least part of the housing is constructed from a translucent plastic, the light barrier being arranged on at least one of a transmitting side and a receiving side outside of the housing.

11. A servo drive for driving a final control element of a mechanical system bidirectionally, comprising:
a bidirectionally movable actuating rod;
an actuating device actuating the actuating rod that is connected in driving manner to the final control element to be driven,
a position sensing device for generating an electrical position signal correlating with a relative position of the actuation rod,
wherein one of the following is selected:
i. the actuating device includes a pressure cell having two chambers with differing pressure conditions, a diaphragm connected in driving manner to the actuating rod, wherein the two chambers are separated by the diaphragm, a housing of the pressure cell that is constructed at least partly from a translucent plastic, a lug provided inside one of the two chambers that constitutes a clean chamber and is attached permanently to the actuating rod, at least one light barrier detecting an end position of the lug that is situated outside the pressure cell, and the position sensing device is formed by the light barrier cooperating with the lug, and
ii. the position sensing device comprises:
two components where the electrical position signal correlates with a relative position between the two components, wherein one component is arranged on the other component so as to be movable bidirectionally in a stroke direction,
a lug including a travel path, included with the first component;
at least one light barrier included with the second component, where the at least one light barrier is located in the travel path of the lug and which generates an electrical position signal that is correlated with the relative position of the two components depending on the relative position between the lug and the light barrier, and
at least one light emitting transmitting device located on the light barrier on one side of the lug and at least one light-sensitive receiving device on the other side of the lug,
wherein the lug has an arrangement of one of adjacent translucent and adjacent non-translucent surfaces, which together form a coding.

12. The actuating device according to claim 1, wherein the pressure cell is constructed entirely from the translucent plastic.

13. The actuating device according to claim 2, wherein the lug has an arrangement of adjacent surfaces that are one of translucent and non-translucent, and which together form a coding, at least one light emitting diode is arranged on one side of the lug, and at least one light-sensitive transistor is arranged on the other side of the lug outside the chamber.

14. The actuating device according to claim 2, wherein a plastic part of one of the chambers is injected such that mirrors are formed on the inside thereof and these mirrors distribute light from a light emitting diode.

15. The actuating device according to claim 2, wherein the at least one light barrier is a reflection light barrier, wherein the movement of the lug is registered by a chip.

16. The position sensing device according to claim 7, wherein the light barrier is designed as a reflection light barrier that calculates the movement of the lug and converts the movement into a position signal by a chip.

17. The servo drive according to claim 11, wherein item i is selected, and the light barrier is a fork light barrier that is located in an end area of the lug and determines the end position of the lug.

18. The servo drive according to claim 11, wherein item i is selected, and the lug has an arrangement of adjacent surfaces that are one of translucent and non-translucent, and which together form a coding, at least one light emitting diode is arranged on one side of the lug, and at least one light-sensitive transistor is arranged on the other side of the lug outside the chamber.

19. The servo drive according to claim 11, wherein item ii is selected, and the second component has a mirror arrangement to distribute light of a transmitting device to one of multiple receiving devices and one receiving array.

20. The servo drive according to claim 11, wherein item ii is selected, and the light barrier is designed as a reflection light barrier that calculates the movement of the lug and converts the movement into a position signal by a chip.
